(19) United States
(12) Patent Application Publication
(10) Pub. No.: US 2025/0245529 A1
(43) Pub. Date: Jul. 31, 2025

(54) TRANSFER LEARNING DEVICE, TRANSFER LEARNING METHOD, AND STORAGE MEDIUM STORING TRANSFER LEARNING PROGRAM

(71) Applicant: Mitsubishi Electric Corporation, Tokyo (JP)

(72) Inventor: Tomoya FUJINO, Tokyo (JP)

(73) Assignee: Mitsubishi Electric Corporation, Tokyo (JP)

(21) Appl. No.: 19/182,342

(22) Filed: Apr. 17, 2025

Related U.S. Application Data
(63) Continuation of application No. PCT/JP2022/047265, filed on Dec. 22, 2022.

(51) Int. Cl. G06N 5/022

(52) U.S. Cl. CPC G06N 5/022

(57) ABSTRACT

A transfer learning device includes: a knowledge transfer learning unit to perform knowledge transfer learning using learning data related to a second type of data different from a first type of data on a basis of a trained model related to the first type of data, and generate an intermediate model from the trained model; and a knowledge transfer progress degree determination unit to determine in the generated intermediate model, by a multiple comparison test, whether or not a reference likelihood of learning data assigned a reference label is larger than likelihoods of a plurality of items of learning data assigned respective non-reference labels other than the reference label.

### CROSS REFERENCE TO RELATED APPLICATION

This application is a Continuation of PCT International Application No. PCT/JP2022/047265, filed on Dec. 22, 2022, which is hereby expressly incorporated by reference into the present application.

### TECHNICAL FIELD

The present disclosure relates to a transfer learning technique.

### BACKGROUND ART

When data of a certain modality (data type) is newly handled, and when there is a model asset that has been sufficiently trained for a modality different from this certain modality by machine learning, knowledge related to this model asset may be transferred and utilized. Patent Literature 1 discloses a technique related to such knowledge transfer. More specifically, Patent Literature 1 discloses a method of learning including: learning data to which a label has been assigned, using a Root Mean Squared Error (RMSE) as a loss function, setting as an end condition a condition that learning is ended without waiting for the maximum number of epochs 50 when loss does not decrease over five epochs, and using a Mean Absolute Error (MAE) and a coefficient of determination (R²) as evaluation indices for evaluating accuracy of a modality of a knowledge transfer destination.

### CITATION LIST

### Patent Literature

Patent Literature 1: JP 2021/135726 A

### SUMMARY OF INVENTION

### Technical Problem

A method disclosed in Patent Literature 1 uses an evaluation index for evaluating accuracy of a modality of a knowledge transfer destination, so that it is possible to ensure quality of knowledge transfer by setting an appropriate threshold related to the evaluation index.

However, according to the conventional method that is described in Patent Literature 1 or the like and searches for minimum loss using a loss function, learning data is equivalently learned irrespectively of whether or not the learning data is sufficiently learned data, and therefore there is a problem that a long learning time is required.

The present disclosure has been made to solve such a problem, and an object of the present disclosure is to provide a transfer learning technique that can reduce a learning time of transfer learning.

### Solution to Problem

One aspect of a transfer learning device according to an embodiment of the present disclosure includes: knowledge transfer learning circuitry to perform knowledge transfer learning using learning data related to a second type of data different from a first type of data on a basis of a trained model related to the first type of data, and generate an intermediate model from the trained model; and knowledge transfer progress degree determination circuitry to determine in the generated intermediate model, by a multiple comparison test, whether or not a reference likelihood of learning data assigned a reference label is larger than likelihoods of a plurality of items of learning data assigned respective non-reference labels other than the reference label.

### Advantageous Effects of Invention

The transfer learning device according to the embodiments of the present disclosure can reduce a learning time of transfer learning.

### BRIEF DESCRIPTION OF DRAWINGS

FIG. 1 is a diagram illustrating a configuration example of a transfer learning device according to Embodiment 1.

FIG. 2A is a diagram illustrating a configuration example of hardware of the transfer learning device.

FIG. 2B is a diagram illustrating a configuration example of hardware of the transfer learning device.

FIG. 3 is a diagram illustrating an outline of transfer learning.

FIG. 4A illustrates a likelihood transition graph showing a transition of a likelihood of a visible image according to an intermediate model generated by transfer learning.

FIG. 4B illustrates a likelihood transition graph showing a transition of a likelihood of a depth image according to the intermediate model generated by transfer learning.

FIG. 5A is a diagram illustrating a target range of a p value table created for a visible image.

FIG. 5B is a diagram illustrating a target range of a p value table created for a depth image.

FIG. 6A illustrates the p value tables of the visible image and the depth image in S1.

FIG. 6B illustrates the p value tables of the visible image and the depth image in S2.

FIG. 6C illustrates the p value tables of the visible image and the depth image in S3.

FIG. 7 is a flowchart illustrating a transfer learning method according to Embodiment 1.

FIG. 8 is a diagram illustrating a configuration example of a transfer learning device according to Embodiment 2.

FIG. 9A illustrates a p value table of the depth image.

FIG. 9B illustrates a p value table of the depth image.

FIG. 9C illustrates a p value table of the depth image.

FIG. 10 is a flowchart illustrating a transfer learning method according to Embodiment 2.

### DESCRIPTION OF EMBODIMENTS

Hereinafter, various embodiments of the present disclosure will be described in detail below with reference to the accompanying drawings. Note that components assigned the identical or similar reference numerals in the drawings will have identical or similar components or functions, and redundant description of these components will be omitted.

### Embodiment 1

### Configuration

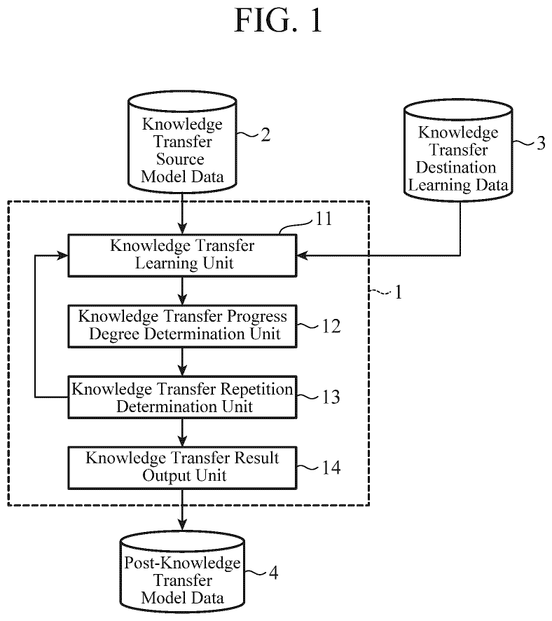

A transfer learning device 1 according to Embodiment 1 of the present disclosure will be described with reference FIGS. 1 to 6C. FIG. 1 is a diagram illustrating a configuration of the transfer learning device 1 according to Embodiment 1. The transfer learning device 1 is a device that performs transfer learning of transferring knowledge related to a transfer source (source) to a transfer destination (target).

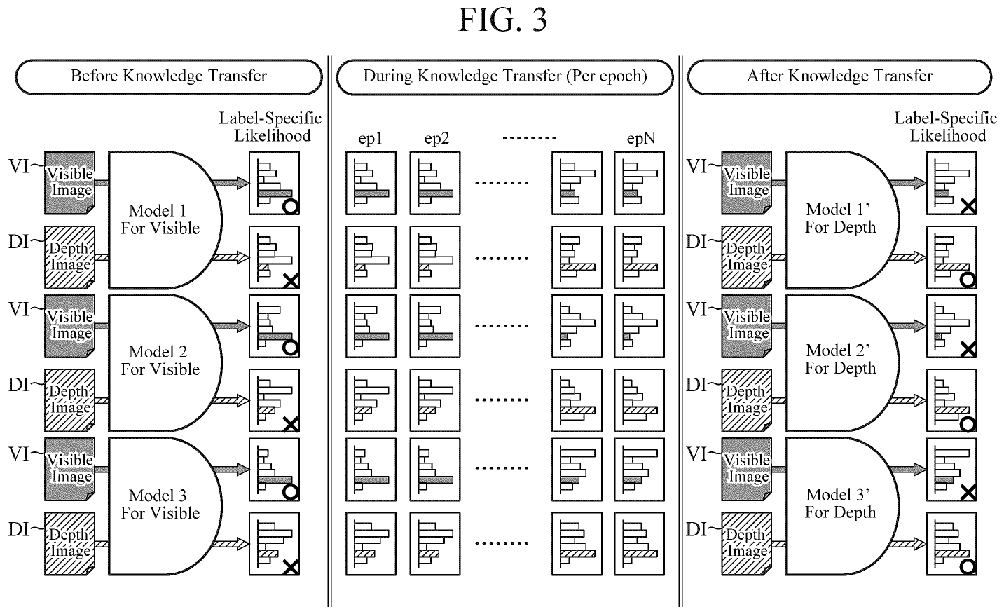

Referring to FIG. 3, for example, the transfer learning device 1 transfers knowledge of a model 1 related to a domain of a visible image that has been sufficiently trained for what a target captured in the visible image is, and generates a model 1′ that makes it possible to determine what a target captured in a depth image is. In other words, the transfer learning device 1 is a device that performs heterogeneous transfer learning whose feature space is different and whose task is identical.

In a phase “before knowledge transfer” illustrated in FIG. 3, the model 1 is a trained model that has been sufficiently trained for the visible image, so that it is possible to appropriately determine what a certain target is from a visible image VI obtained by imaging the certain target. In FIG. 3, likelihoods of correct labels of visible images are indicated by gray. Since the likelihoods of the correct labels of the visible image are maximum, appropriate determination is performed (indicated by “○” in FIG. 3). However, the model 1 cannot appropriately determine what a certain target is from the depth image DI obtained by imaging the certain target. In FIG. 3, likelihoods of correct labels of depth images are indicated by hatching. Since the likelihoods of the correct labels indicated by the hatching are not maximum, appropriate determination is not performed (indicated by “x” in FIG. 3).

In a phase “after knowledge transfer” illustrated in FIG. 3, a model 1′ is a trained model generated by transfer learning using a depth image on the basis of the model 1. Consequently, the model 1′ can appropriately determine what a certain target is from the depth image DI obtained by imaging the certain target. Since the likelihoods of the correct labels indicated by the hatching are maximum, appropriate determination is performed (indicated by “○” in FIG. 3). On the other hand, the model 1′ is trained for depth images, and therefore cannot appropriately determine what a certain target is from the visible image VI obtained by imaging the certain target as illustrated in FIG. 3. The likelihoods of the correct labels of the visible images are not maximum, and therefore appropriate determination is not performed (indicated by “x” in FIG. 3). Note that, depending on the degree of similarity of a domain of the knowledge transfer source and a domain of the knowledge transfer destination, the degree of determination capability of the model 1′ for the domain of the knowledge transfer source changes.

In FIG. 3, the phase “during knowledge transfer” between before knowledge transfer and after knowledge transfer indicates how a determination result of an intermediate model during knowledge transfer changes.

The transfer learning device 1 may generate a single model such as the model 1′ on the basis of a plurality of models 1 to 3 related to the domain of the knowledge transfer source.

To perform the above transfer learning, as illustrated in FIG. 1, the transfer learning device 1 includes a knowledge transfer learning unit 11, a knowledge transfer progress degree determination unit 12, a knowledge transfer repetition determination unit 13, and a knowledge transfer result output unit 14. The transfer learning device 1 is connected with a storage device 2 that stores data related to knowledge of the knowledge transfer source, a storage device 3 that stores data related to knowledge of the knowledge transfer destination, and a storage device 4 that stores data related to knowledge of the knowledge transfer destination after knowledge transfer to constitute a transfer learning system.

The data stored in the storage device 2 is data of a trained model that has already been sufficiently trained. For example, data of the trained model for a visible image to which a label has been assigned is stored, the trained model having been sufficiently trained in such a way as to determine whether, for example, a target shown in a visible image is a person or a car. An example of such a trained model includes ImageNet. A target of the trained model may be an image other than visible images. For example, the target may be an infrared image or a thermal image. Furthermore, the target of the trained model is not limited to images. For example, the target of the trained model may be a measurement value which is measured using an unillustrated sensor and expressed two-dimensionally, such as a reflectance, a reflection intensity, or a frequency, or may be a frequency distribution.

The data stored in the storage device 3 is data for learning at the knowledge transfer destination. For example, data for learning of depth images such as people, cars, and buildings is stored. Each depth image is assigned a label indicating what a shown target is. The depth image is also referred to as a distance image, and is an image that has a distance value as a pixel value. As long as learning data to be stored has a different modality from a modality of data to be stored in the storage device 2, the learning data may be an image other than depth images, or may be a two-dimensionally expressed measurement value or frequency distribution other than the images.

As data to be stored in the storage device 4, data of a post-knowledge transfer model is stored. When, for example, a new model is formed by using knowledge of a trained model for a visible image stored in the storage device 2 and learning data of a depth image stored in the storage device 3, the post-knowledge transfer model is a trained model for the depth image.

### Knowledge Transfer Learning Unit

Hereinafter, a configuration of the transfer learning device 1 will be described in more detail. The following description will be given assuming that data stored in the storage device 2 is trained model data for a visible image, and data stored in the storage device 3 is learning data of a depth image.

The knowledge transfer learning unit 11 is a function unit that performs knowledge transfer learning using learning data related to a second type of data different from a first type of data on the basis of a trained model related to the first type of data, and generates an intermediate model from the trained model. The knowledge transfer learning unit 11 performs such learning when acquiring the trained model and the learning data for the first time and when accepting an output indicating to repeat knowledge transfer learning from the knowledge transfer repetition determination unit 13. More specifically, the knowledge transfer learning unit 11 acquires data such as a structure and weight coefficient data of nodes of a neural network of the trained model related to a visible image as data related to a modality (data type) of the knowledge transfer source from the storage device 2. Furthermore, the knowledge transfer learning unit 11 acquires learning data related to depth images as data related to the modality of the knowledge transfer destination from the storage device 3. The knowledge transfer learning unit 11 uses these items of acquired data to perform knowledge transfer learning using the learning data related to the depth images on the basis of the trained model related to the visible images. Knowledge transfer learning is performed using a known technique described in Patent Literature 1 or the like. The knowledge transfer learning unit 11 generates an intermediate model during knowledge transfer by performing knowledge transfer learning, and outputs the generated intermediate model. The output intermediate model may be temporarily stored in an unillustrated storage device.

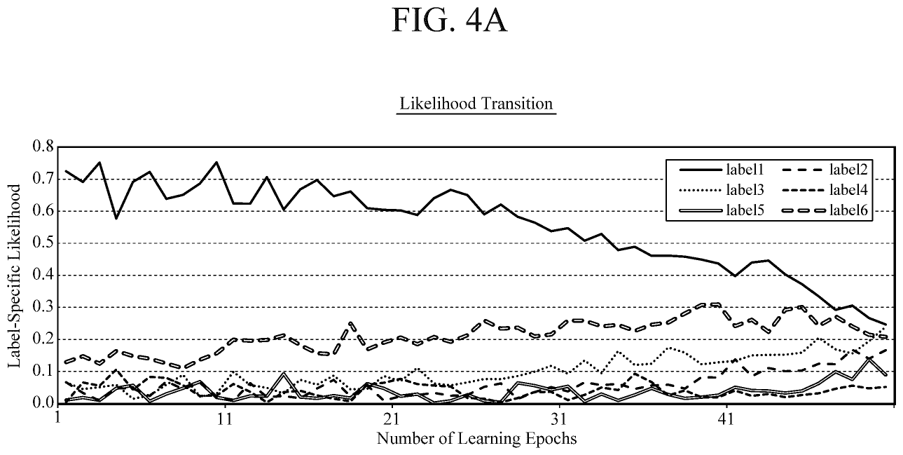

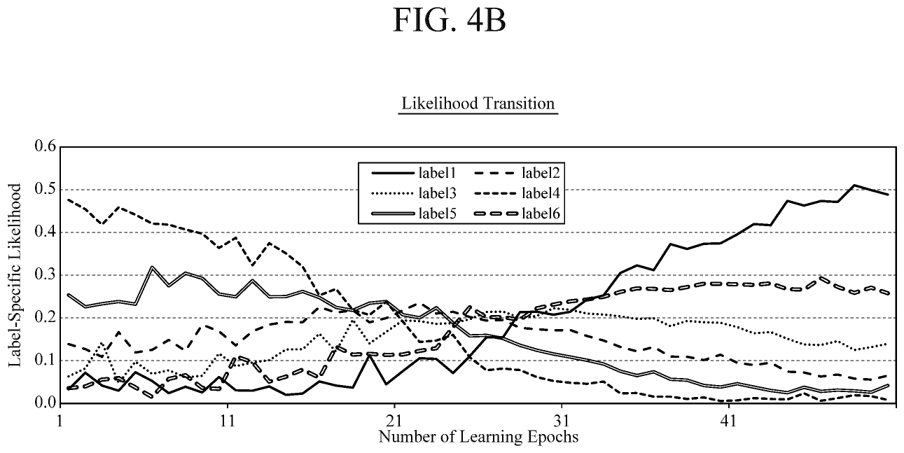

The intermediate model to be generated is gradually adapted to the modality of the knowledge transfer destination by transfer learning. FIGS. 4A and 4B are diagrams illustrating how this transformation occurs. FIG. 4A illustrates a likelihood transition graph showing a transition of a likelihood of a visible image according to the intermediate model generated by transfer learning. FIG. 4B illustrates a likelihood transition graph showing a transition of a likelihood of a depth image according to the intermediate model generated by transfer learning. A correct label is assumed as label 1 at any one of the knowledge transfer source and the knowledge transfer destination.

In FIG. 4A, since a base model is a trained model for visible images, the generated intermediate model determines with a high likelihood that an input visible image is an image of label 1 at a phase immediately after transfer learning is started, that is, at, for example, stages of the number of epochs 1 to 10. However, the intermediate model transforms to a model for depth images as transfer learning progresses, and therefore the generated intermediate model cannot determine with a high likelihood that an input visible image is an image of label 1 at a phase that is a while after transfer learning is started, that is, at, for example, stages of the number of epochs 41 to 50.

On the other hand, as illustrated in FIG. 4B, the intermediate model cannot determine with a high likelihood that the input depth image is the image of label 1 at the phase immediately after transfer learning is started, yet can determine with a high likelihood that the input depth image is the image of label 1 at the phase that is a while after transfer learning is started.

Although a base model is assumed as a single trained model for visible images in FIGS. 4A and 4B, a plurality of trained models of visible images may be used as the base models. The plurality of base models are generally learned using different data sets even for a visible image to which the same label has been assigned, so that, by integrating and transferring knowledge of the plurality of models, it is possible to increase determination accuracy of a learning model to be generated. The base models include the model 1, the model 2, and the model 3. In this case, in FIGS. 4A and 4B, by assigning the number of epochs 1, 4, 7, 10, and . . . to epochs of the model 1, assigning the number of epochs 2, 5, 8, 11, and . . . to epochs of the model 2, assigning the number of epochs 3, 6, 9, 12, and . . . to epochs of the model 3, and processing each of three consecutive epochs (the number of epochs 1 to 3, 4 to 6, 7 to 9, 10 to 12, and . . . ) as one unit, it is possible to integrally transfer knowledge from the plurality of trained models.

### Knowledge Transfer Progress Degree Determination Unit

The knowledge transfer progress degree determination unit 12 is a function unit that determines the degree of progress of knowledge transfer learning. More specifically, the knowledge transfer progress degree determination unit 12 determines the degree of progress of knowledge transfer learning, by determining in the intermediate model generated by the knowledge transfer learning unit 11, by a multiple comparison test, whether or not a reference likelihood of learning data assigned a reference label is larger than likelihoods of a plurality of items of learning data assigned respective non-reference labels other than the reference label. Since what degree of difference between likelihoods allows determination that there is a magnitude relation is not clear, whether or not there is the magnitude relation is determined by a multiple comparison test on the basis of a common index that is the degree of confidence or a confidence interval.

The multiple comparison test refers to a method of testing between which groups there is a difference when measurement values of a plurality of three or more groups are measured. As for the method of conducting the multiple comparison test, for example, a multiple comparison test of Dunnett described in following Non-Patent Literature 1 can be used. Note that a multiple comparison test scheme is not limited to the Dunnett method, and may be other schemes such as the Williams test or the Tukey test.
Non-Patent Literature 1: “Theory of Multiple Comparison Procedures and Its Computation” written by Takaaki SHIRAISHI and Hiroshi SUGIURA, KYORITSU SHUPPAN CO., LTD. pp. 76 to 81 (2018).

According to the multiple comparison test of Dunnett, when average values of measurement value groups are compared, a value that is called an “allowance” is calculated from the measurement value groups of a plurality of trials depending on a degree of confidence p. When an average value of a sample that serves as a reference and an average value of each sample have a magnitude relation that exceeds this allowance, it is determined that the magnitude relation holds at the degree of confidence p. A value of p that serves as a boundary to determine whether the magnitude relation holds or does not hold is referred to as a p value.

The knowledge transfer progress degree determination unit 12 calculates the p value from a likelihood of image data input to the intermediate model to determine in the intermediate model output from the knowledge transfer learning unit 11, by the multiple comparison test, whether or not the reference likelihood of learning data assigned the reference label is larger than likelihoods of a plurality of items of learning data assigned respective the non-reference labels other than the reference label. The p value varies in an epoch unit, and therefore is calculated from likelihoods of image data in a plurality of epochs.

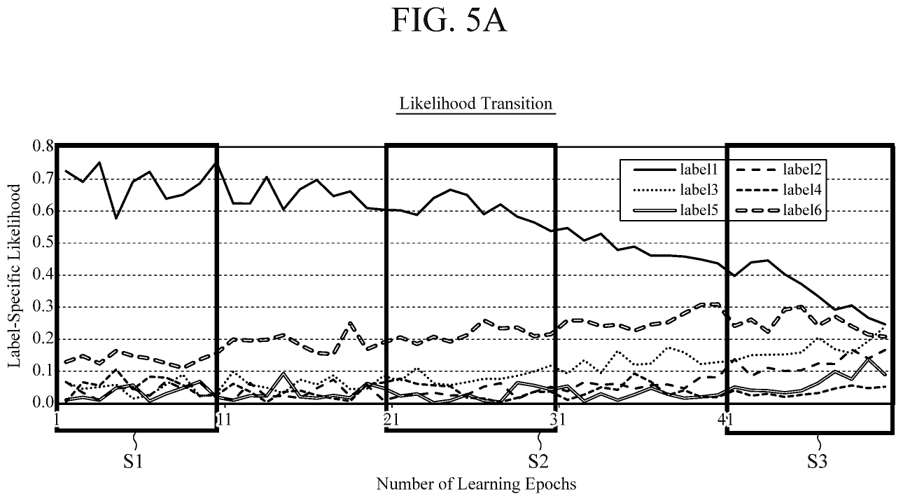

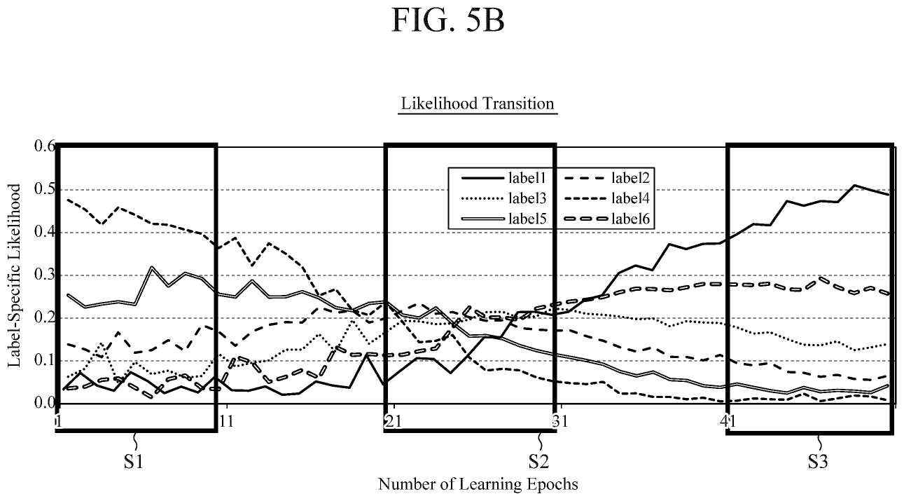

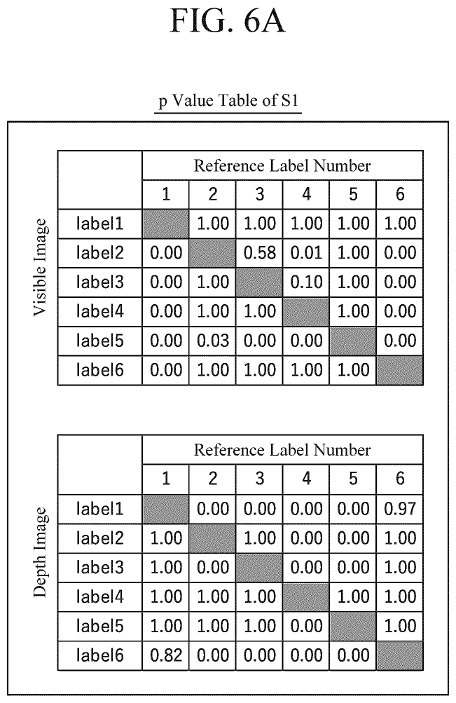

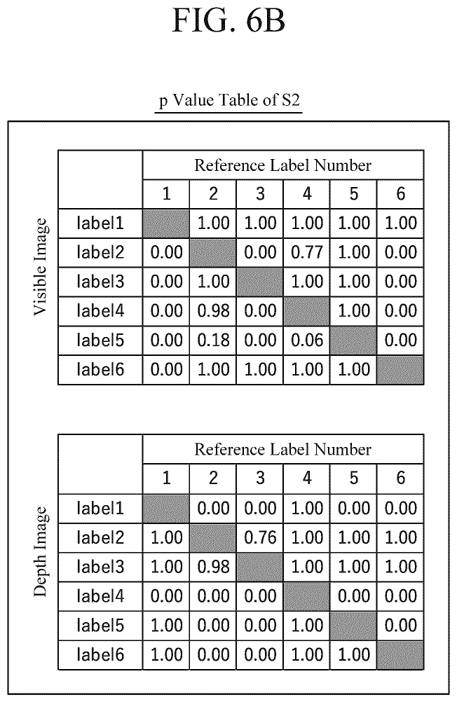

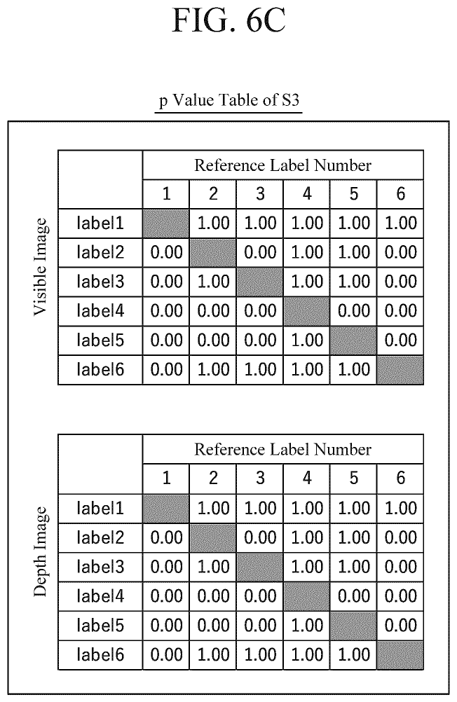

FIGS. 6A to 6C illustrate tables showing examples of the calculated p values. FIG. 6A illustrates a p value table of a section S1 in FIG. 5A illustrating a likelihood transition of a visible image, and illustrates a p value table of the section S1 in FIG. 5B illustrating a likelihood transition of a depth image. Furthermore, FIG. 6B illustrates a p value table of a section S2 in FIG. 5B illustrating a likelihood transition of a visible image, and illustrates a p value table of the section S2 in FIG. 5B illustrating a likelihood transition of a depth image. Furthermore, FIG. 6C illustrates a p value table of a section S3 in FIG. 5A illustrating a likelihood transition of a visible image, and illustrates a p value table of the section S3 in FIG. 5B illustrating a likelihood transition of a depth image. Note that the likelihood transition in FIG. 5A is identical to that in FIG. 4A, and the likelihood transition in FIG. 5B is identical to that in FIG. 4B. Furthermore, the section S1 is a section of the number of epochs 1 to 10, the section S2 is a section of the number of epochs 21 to 30, and the section S3 is a section of the number of epochs 41 to 50. By conducting the multiple comparison test once, it is possible to evaluate a magnitude relation between a plurality of other labels (e.g., label 2 to label 6) for which a certain label (e.g., label 1) serves as a reference, and calculate the p value of each cell of one column (e.g., a column of label 1) of the p value table. By conducting the multiple comparison test using another label (e.g., label 2) as the reference label, it is possible to evaluate a magnitude relation between a plurality of other labels (e.g., label 1 and label 3 to label 6) for which this another label (e.g., label 2) serves as the reference, and calculate the p value of each cell of one column (e.g., a column of label 2) of the p value table.

According to the multiple comparison test, it is concluded that, when the p value of a cell at which a column of a reference label number and a row of a non-reference label other than the reference label intersects is 0.05 or less, a score value of the non-reference label is smaller than that of the reference label at the degree of confidence of 95%. Furthermore, it can be said that the p values of all cells of the columns of the reference label number are 0.05 or less, the reference label is maximum.

By setting a correct label as the reference label using such a multiple comparison test method, the knowledge transfer progress degree determination unit 12 determines in the intermediate model output from the knowledge transfer learning unit 11 whether or not the reference likelihood of learning data assigned the reference label (i.e., correct label) is larger than likelihoods of a plurality of items of learning data assigned the respective non-reference labels other than the reference label, and outputs a result of the determination. Note that, when the reference label is label 1, the non-reference labels correspond to label 2 to label 6.

### Knowledge Transfer Repetition Determination Unit

The knowledge transfer repetition determination unit 13 determines whether or not to repeat knowledge transfer learning on the basis of the determination result output from the knowledge transfer progress degree determination unit 12. More specifically, the knowledge transfer repetition determination unit 13 determines to not repeat knowledge transfer learning when it is indicated that the reference likelihood of the reference label is larger than the likelihoods of all non-reference labels other than the reference label, and determines to repeat knowledge transfer learning when this is not the case (when it is not indicated that the reference likelihood is larger than the likelihoods of all non-reference labels). The knowledge transfer repetition determination unit 13 outputs a result of determination on whether or not to repeat knowledge transfer learning.

### Knowledge Transfer Result Output Unit

When accepting the result of determination by the knowledge transfer repetition determination unit 13 that knowledge transfer learning is not repeated, the knowledge transfer result output unit 14 recognizes that the intermediate model is a post-knowledge transfer trained model for which knowledge transfer has been completed, and outputs data of the post-knowledge transfer trained model that is a result of knowledge transfer to the storage device 4.

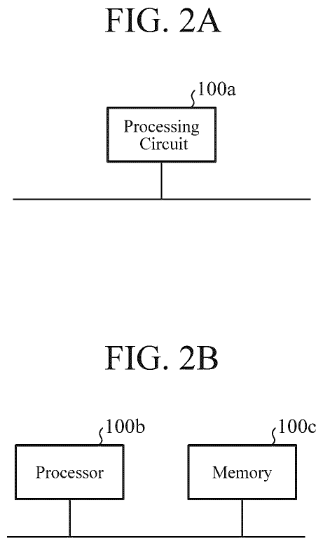

Next, the hardware configuration example of the transfer learning device 1 will be described with reference to FIGS. 2A and 2B. Function units of the transfer learning device 1 are implemented by processing circuitry. That is, the transfer learning device 1 includes processing circuitry for performing various arithmetic operations such as knowledge transfer learning, knowledge transfer progress degree determination, knowledge transfer repetition determination, and knowledge transfer result output. The processing circuitry may be a dedicated processing circuit 100a illustrated in FIG. 2A, or may be a computer that includes a processor 100b that executes programs stored in a memory 100c illustrated in FIG. 2B.

In a case where the processing circuitry is the dedicated processing circuit 100a, the dedicated processing circuit 100a corresponds to, for example, a single circuit, a composite circuit, a programmed processor, a parallel-programmed processor, an Application Specific Integrated Circuit (ASIC), a Field-Programmable Gate Array (FPGA), or a combination thereof. The functions of respective units of the knowledge transfer learning unit 11, the knowledge transfer progress degree determination unit 12, the knowledge transfer repetition determination unit 13, and the knowledge transfer result output unit 14 may be implemented by a plurality of different processing circuits, or the functions of the units may be collectively implemented by a single processing circuit.

In a case where the processing circuitry is the processor 100b, each function of the knowledge transfer learning unit 11, the knowledge transfer progress degree determination unit 12, the knowledge transfer repetition determination unit 13, and the knowledge transfer result output unit 14 may be implemented by software, firmware, or a combination of software and firmware. The software and the firmware are described as programs, and stored in the memory 100c. The processor 100b implements the function of each unit by reading and executing the programs stored in the memory. That is, the memory 100c for storing a program (transfer learning program) that eventually executes steps such as a step of performing knowledge transfer learning, a step of performing knowledge transfer progress degree determination, a step of performing knowledge transfer repetition determination, and a step of performing knowledge transfer result output is provided. Here, examples of the memory 100c include a non-volatile or volatile semiconductor memory such as a Random Access Memory (RAM), a Read-Only Memory (ROM), a flash memory, an Erasable Programmable Read Only Memory (EPROM), or an Electrically Erasable programmable Read-Only Memory (EEPROM), a magnetic disk, a flexible disk, an optical disk, a compact disk, a mini disk, and a DVD.

Note that part of the functions of the knowledge transfer learning unit 11, the knowledge transfer progress degree determination unit 12, the knowledge transfer repetition determination unit 13, and the knowledge transfer result output unit 14 may be implemented by dedicated hardware, and part of the functions may be implemented by software or firmware. Thus, the processing circuitry can implement each of the above-described functions by using hardware, software, firmware, or a combination thereof.

### Operation

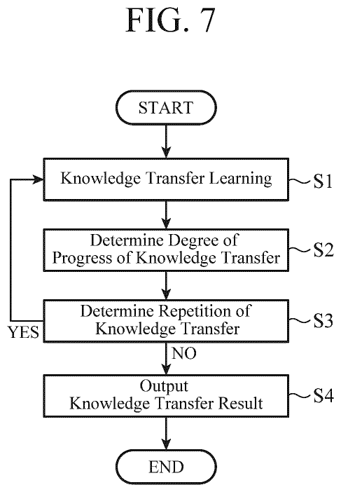

Next, an operation of the transfer learning device 1 will be described with reference FIG. 7. In step S1, the knowledge transfer learning unit 11 performs knowledge transfer learning using learning data related to a second type of data different from a first type of data on the basis of a trained model related to the first type of data, and generates an intermediate model from the trained model.

In step S2, the knowledge transfer progress degree determination unit 12 determines in the intermediate model generated by the knowledge transfer learning unit 11, by the multiple comparison test, whether or not the reference likelihood of learning data assigned the reference label is larger than likelihoods of a plurality of items of learning data assigned respective non-reference labels other than the reference label. The knowledge transfer progress degree determination unit 12 outputs a result of the determination.

In step S3, the knowledge transfer repetition determination unit 13 determines whether or not to repeat knowledge transfer learning on the basis of the determination result output from the knowledge transfer progress degree determination unit 12. More specifically, the knowledge transfer repetition determination unit 13 determines to not repeat knowledge transfer learning when it is indicated that the reference likelihood of the reference label is larger than the likelihoods of all non-reference labels other than the reference label, and determines to repeat knowledge transfer learning when this is not the case (when it is not indicated that the reference likelihood is larger than the likelihoods of all non-reference labels). The processing returns to step S1 when it is determined to repeat knowledge transfer learning, and the processing moves to step S4 when it is determined to not repeat knowledge transfer learning.

In step S4, when accepting the result of determination by the knowledge transfer repetition determination unit 13 that knowledge transfer learning is not repeated, the knowledge transfer result output unit 14 recognizes that the intermediate model is a post-knowledge transfer trained model for which knowledge transfer has been completed, and outputs data of the post-knowledge transfer trained model that is a result of knowledge transfer.

The above-described transfer learning device 1 can evaluate for each non-reference label the degree of progress of learning of items of learning data assigned a plurality of non-reference labels with respect to learning data assigned the reference label. Consequently, it is possible to identify learning data whose progress of transfer learning is delayed, and provide a base for intensively learning the learning data whose progress of transfer learning is delayed. Consequently, it is possible to reduce a learning time of transfer learning.

### Embodiment 2

### Configuration

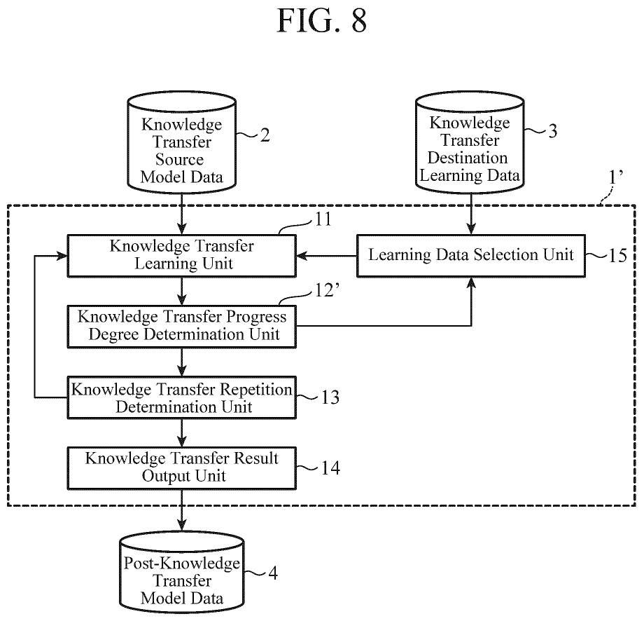

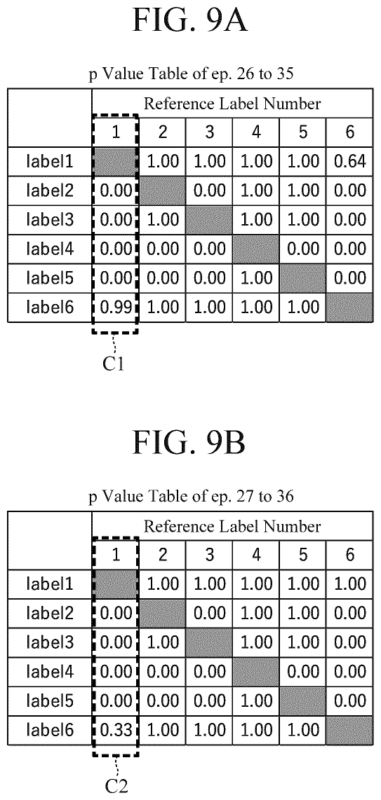

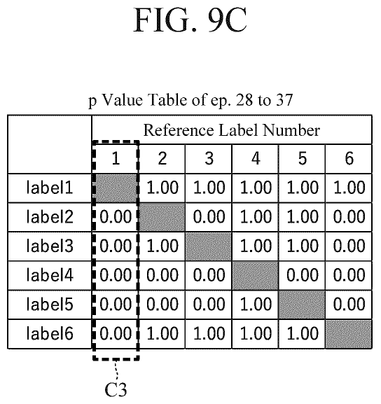

Next, a transfer learning device 1′ according to Embodiment 2 of the present disclosure will be described with reference FIGS. 8 to 9C. The transfer learning device 1′ according to Embodiment 2 differs from the transfer learning device 1 according to Embodiment 1 in additionally including a learning data selection unit 15. Since the learning data selection unit 15 is added, the function of a knowledge transfer progress degree determination unit 12′ included in the transfer learning device 1′ is slightly different from that of the knowledge transfer progress degree determination unit 12 of the transfer learning device 1.

In the transfer learning device 1′ according to Embodiment 2, the knowledge transfer progress degree determination unit 12′ determines the degree of progress of knowledge transfer learning by determining whether or not there is learning data whose progress of knowledge transfer is delayed. Determination on whether or not there is such learning data is performed by specifying from a multiple comparison test result a non-reference label whose p value is smaller than a predetermined value. Thus, when it is not determined that the reference likelihood is larger than likelihoods of a plurality of items of learning data assigned respective non-reference labels, the knowledge transfer progress degree determination unit 12′ specifies from the multiple comparison test result the non-reference label whose p value is smaller than the predetermined value.

The learning data selection unit 15 is a function unit that, when it is not determined that the reference likelihood is larger than the likelihoods of the plurality of items of learning data assigned the respective non-reference labels, selects learning data that contributes to not determining that the reference likelihood is larger than the likelihoods of the plurality of items of learning data. More specifically, the learning data selection unit 15 selects (that is, acquires) learning data to which a label specified by the knowledge transfer progress degree determination unit 12′ has been assigned from the storage device 3, and supplies the selected learning data to the knowledge transfer learning unit 11. The knowledge transfer learning unit 11 performs transfer learning using the learning data selected by the learning data selection unit 15.

Referring to, for example, FIG. 9A, the knowledge transfer progress degree determination unit 12′ specifies label 6 from a column C1 whose reference label number is 1 in a p value table in FIG. 9A calculated from likelihoods of depth images at the number of epochs 26 to 35. Label 6 is specified by determining whether or not the value of the p value is a predetermined value such as 0.05 or less. The learning data selection unit 15 selects learning data assigned label 6 from the storage device 3, and supplies the selected learning data to the knowledge transfer learning unit 11. The p values of label 1 to label 5 equal to or less than the predetermined value in FIG. 9A indicate that learning of label 1 to label 5 has sufficiently progressed. On the other hand, the p value of label 6 larger than the predetermined value indicates that learning of label 6 has not sufficiently progressed. Hence, label 6 whose degree of progress of learning is delayed compared to the other labels is intensively learned.

By intensively learning depth images of label 6, the p value of label 6 is remarkably reduced as illustrated in FIGS. 9B and 9C. FIG. 9B illustrates a p value table calculated from likelihoods of depth images at the number of epochs 27 to 36, and FIG. 9C illustrates a p value table calculated from likelihoods of depth images at the number of epochs 28 to 37. By intensively learning the depth images of label 6, the p value of label 6 is reduced to 0.33 in a column C2 in FIG. 9B, and to 0.00 in a column C3 in FIG. 9C.

As described above, by intensively learning data whose degree of progress of learning is delayed, it is possible to reduce the number of times of learning of data whose degree of progress of learning is delayed, so that it is possible to reduce a learning time required for entire transfer learning.

Hardware of the transfer learning device 1′ can be implemented by the configuration example in FIG. 2A or 2B similar to the configuration example of the hardware of the transfer learning device 1 according to Embodiment 1.

### Operation

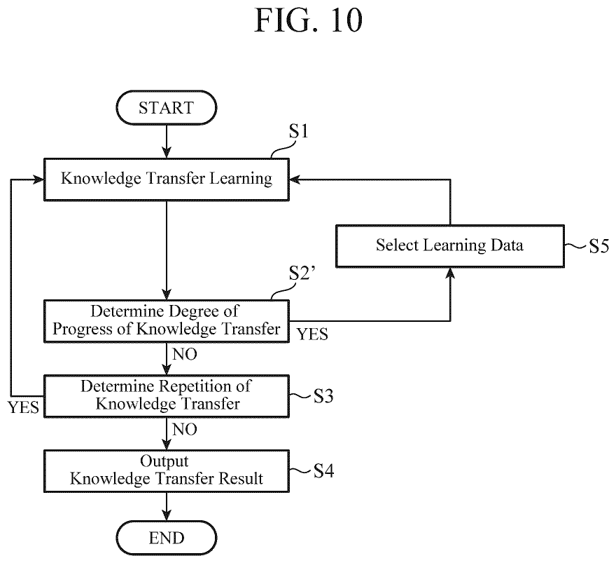

Next, an operation of the transfer learning device 1′ will be described with reference FIG. 10. Since steps S1, S3, and S4 are the same as the steps in FIG. 7, description thereof will be omitted.

In step S2′, the knowledge transfer progress degree determination unit 12′ determines whether or not there is learning data whose progress of knowledge transfer is delayed. The processing moves to step S5 when there is learning data whose progress of learning is delayed, and the processing moves to step S3 when there is not learning data whose progress of learning is delayed.

In step S5, the learning data selection unit 15 selects from the storage device 3 learning data for which the knowledge transfer progress degree determination unit 12 has determined that the progress of knowledge transfer is delayed, and supplies the selected learning data to the knowledge transfer learning unit 11. Then, the processing step returns to step S1.

Note that the embodiments can be combined, and each embodiment can be modified or omitted as appropriate.

### INDUSTRIAL APPLICABILITY

The transfer learning device according to the present disclosure can be used as a device that transfers and utilizes knowledge related to a model asset that has already been sufficiently learned by machine learning, and can be used in a technical field such as video image analysis.

### REFERENCE SIGNS LIST

1 (1′): transfer learning device, 2: storage device, 3: storage device, 4: storage device, 11: knowledge transfer learning unit, 12 (12′): knowledge transfer progress degree determination unit, 13: knowledge transfer repetition determination unit, 14: knowledge transfer result output unit, 15: learning data selection unit, 100a: processing circuit, 100b: processor, 100c: memory.

1. A transfer learning device comprising:
knowledge transfer learning circuitry to perform knowledge transfer learning using learning data related to a second type of data different from a first type of data on a basis of a trained model related to the first type of data, and generate an intermediate model from the trained model; and
knowledge transfer progress degree determination circuitry to determine in the generated intermediate model, by a multiple comparison test, whether or not a reference likelihood of learning data assigned a reference label is larger than likelihoods of a plurality of items of learning data assigned respective non-reference labels other than the reference label.

2. The transfer learning device according to claim 1, further comprising learning data selection circuitry to, when it is not determined that the reference likelihood is larger than the likelihoods of the plurality of items of learning data, select learning data that contributes to not determining that the reference likelihood is larger than the likelihoods of the plurality of items of learning data.

3. The transfer learning device according to claim 1, further comprising knowledge transfer repetition determination circuitry to, when it is determined that the reference likelihood is larger than the likelihoods of the plurality of items of learning data, determines to end the knowledge transfer learning.

4. The transfer learning device according to claim 2, further comprising knowledge transfer repetition determination circuitry to, when it is determined that the reference likelihood is larger than the likelihoods of the plurality of items of learning data, determines to end the knowledge transfer learning.

5. A transfer learning method performed by a transfer learning device, the transfer learning method comprising:
performing knowledge transfer learning using learning data related to a second type of data different from a first type of data on a basis of a trained model related to the first type of data, and generating an intermediate model from the trained model; and
determining in the generated intermediate model, by a multiple comparison test, whether or not a reference likelihood of learning data assigned a reference label is larger than likelihoods of a plurality of items of learning data assigned respective non-reference labels other than the reference label.

6. A non-transitory computer-readable storage medium storing a transfer learning program causing a computer to execute:
a function to perform knowledge transfer learning using learning data related to a second type of data different from a first type of data on a basis of a trained model related to the first type of data, and generate an intermediate model from the trained model; and
a function to determine in the generated intermediate model, by a multiple comparison test, whether or not a reference likelihood of learning data assigned a reference label is larger than likelihoods of a plurality of items of learning data assigned respective non-reference labels other than the reference label.
